(19) United States
(12) Patent Application Publication
(10) Pub. No.: US 2004/0267593 A1
(43) Pub. Date: Dec. 30, 2004

(54) Systems and methods for managing litigation and other matters

(76) Inventors: Barbara N. Sammons, Pittsfield, MA (US); Orrie Dinstein, Armonk, NY (US); Kevin Hoffman, Granite Springs, NY (US); BethMarie Reimer-Weier, Kenosha, WI (US); Joseph Noga, Rye, NY (US)

Correspondence Address: BUCKLEY, MASCHOFF, TALWALKAR LLC, 5 ELM STREET, NEW CANAAN, CT, 06840, US

(21) Appl. No.: 10/867,262

(22) Filed: Jun. 14, 2004

Related U.S. Application Data
(60) Provisional application No. 60/477,516, filed on Jun. 11, 2003.

(51) Int. Cl. G06F 17/60

(52) U.S. Cl. 705/9

(57) ABSTRACT

In some embodiments, systems and methods are provided for managing litigation and other disputes or matters.

### CROSS-REFERENCE TO RELATED APPLICATIONS

This application claims priority and benefit under 35 U.S.C. § 119(e) to U.S. Provisional Patent Application Ser. No. 60/477,516, entitled “Systems and Methods for Managing Litigation and Other Matters”, filed in the name of Sammons et al. on Jun. 11, 2003, the contents of which are hereby incorporated by reference in their entirety for all purposes.

### FIELD

Embodiments of the present invention generally relate to litigation and other matters. More particularly, embodiments may relate to systems and methods for managing litigation or other matters.

### BACKGROUND

Tracking litigation and other disputes can be quite complicated. This is particularly true when it comes to tracking key dates, witnesses and documents, especially when one is faced with numerous matters. For example, large companies often face a wide variety of disputes and a large company may have hundreds, if not thousands of disputes pending at any one time. These disputes can relate to different aspects of the business and may involve diverse or complex legal or technical issues. Errors or mistakes concerning deadlines or obligations can expose the company to varying levels of risk and therefore it is important to track and manage these matters. Mishandling of discovery demands (including preservation obligations) in particular can be extremely risky in a pending litigation. It would be desirable to provide systems and methods for managing litigation that overcome deficiencies in existing systems.

### BRIEF DESCRIPTION OF THE DRAWINGS

FIG. 1 is a block diagram of a litigation management system according to some embodiments.

FIG. 2 is a flow diagram of a method for establishing litigation management rules according to some embodiments.

FIG. 3 is a flow diagram of a method for entering litigation management data according to some embodiments.

FIG. 4 is a flow diagram of a method for entering matter information according to some embodiments.

FIG. 5 is a flow diagram of a method for closing a matter according to some embodiments.

FIG. 6 is a diagram of a portion of a database table according to some embodiments.

FIG. 7 is a diagram of a portion of a database table according to some embodiments.

FIG. 8 is a block diagram of a user device according to some embodiments. FIG. 9 is an exemplary screen display according to some embodiments.

FIG. 10 is a block diagram of a case management device according to some embodiments.

### DETAILED DESCRIPTION

### Introductory Example

Prior to a detailed description of the present invention, a brief introductory example will now be provided to illustrate features of some embodiments of the present invention. This introductory example will be carried through the remainder of the application to describe features of various embodiments of the present invention. In the example, a company (“ABC Corp.”) has implemented features of the present invention to manage litigation matters. The company is a large, multinational organization having two primary business segments: a commercial business, and a consumer business. Each of the business segments operate in both the US and in other regions around the world, and each is actively involved in a large number of disputes at any given time. Each of the business segments has a number of different employees who manage litigation matters. In particular, both segments have their own in-house litigation management counsel and division General Counsels (GCs). Both division GCs report to a corporate GC. Different employees for each of the business segments manage litigation matters arising in different geographic regions. Further, each business segment has adopted different procedures to manage litigation matters.

Despite having different procedures, different employees, and different types of disputes, the business segments share best practices, upper level management and reporting requirements. Embodiments described herein may allow the company (despite having different business segments having different requirements and employees) to efficiently and systematically track and manage litigation matters.

In implementing the system, the ABC Corp. may deploy a litigation management system accessible by a number of user devices as described further below and pursuant to the present invention. System administrators (employees given administrator authority) interact with the system to input data and rules defining the organization structure and defining litigation management rules of the company and of each of the business segments. For example, ABC Corp. may have a company-wide rule that all litigation matters that involve claims that could exceed $50 Million must be reported to the ABC Corp. GC, along with the CEO and CFO. These individuals may also be required to approve any settlement or closure of the matter. The commercial business may have a rule that if the exposure exceeds $25 Million, the commercial business GC must be notified (and is the individual authorized to settle the claim as well). A number of other rules may also be implemented to impose controls and to ensure that litigation matters managed by the system are managed in a systematic and controlled manner.

Once the system has been configured, it is available for data entry. Certain employees may be given authority to add and edit litigation matter information. When a new matter arises, an authorized employee enters the data by interacting with a number of data entry screens (e.g., accessible via a Web browser). As the data is entered, it is compared to any relevant litigation management rules. For example, if an employee in the commercial business enters information about a patent infringement suit that has been filed against ABC Corp. in which the total overall exposure exceeds $50 Million, the rules will require that notifications be sent to the GC, CEO and CFO. Further, the data record associated with the new matter will be associated with information or a rule ensuring that the matter cannot be closed or settled without approval of the appropriate parties. The user entering data will be guided through a series of data entry screens to ensure that all relevant data associated with the matter is entered. Some or all of the data entry screens may be associated with data entry rules that control which users can enter or edit data, which data fields are mandatory, and which data fields contain data that cannot be modified.

Notifications, status emails, and other information may be automatically generated by the system during the life of each matter. In some embodiments, the notifications are automatically generated and transmitted to relevant parties based at least in part on information retrieved from ABC Corp.'s employee database. For example, each member of the commercial business litigation team may automatically receive email messages each time the patent litigation matter is updated or modified. They may also reserve a preservation notice when discovery demands are served on ABC Corp. as well as subsequent reminders to produce the responsive documents and a notice when the matter has concluded so that they may resume implementation of ABC Corp's records management policy. The identification of the litigation team may be performed by referencing the employee database. In this manner, the litigation management system need not be modified each time employee status information changes.

The patent infringement suit may be tracked using the system throughout its pendency. If ABC Corp. wishes to settle the matter (or if ABC Corp. prevails at trial), the closure of the matter must be approved by the designated individuals. If the designated individuals do not authorize the closure, the matter will remain open in the system.

In this manner, embodiments may allow, for example, a company (and each of the various business segments within the company) to establish its own litigation rules and procedures and ensure that employees who enter, view, and edit litigation information comply with these rules. Embodiments may further allow each business to share best practices and information, including performance evaluations, about litigation service providers. Other features, benefits, and/or configurations will become apparent upon reading this disclosure.

### Terms and Definitions

Some embodiments described herein are directed to systems and methods for managing litigation. As used herein, the term “litigation” may generally refer to any of a number of different types of disputes and/or other matters involving claims against (or by) an entity. The term “litigation” may include, for example, actions filed in court either in the United States (e.g., including state, local, federal or other courts) or abroad, as well as administrative disputes and other interactions between an entity and one or more third parties (e.g., governmental investigation). Some embodiments, for example, may be used to track third party subpoenas and/or other actions, issues, documents, and/or matters. The term “litigation” may also or alternatively be used to refer to other non-contentious matters, including, for example, proactive and/or risk mitigation projects undertaken by an organization or other entity. Other matters may be tracked or managed using features of embodiments as well.

As used herein, the entity operating (or utilizing) features of claimed embodiments may generally be referred to as an “organization”. As used herein, the term “organization” may refer to any corporation, company and/or other entity that has a need and/or desire to manage litigation or other matters. For example, an organization may be a large company having a number of different operating units or divisions, each of which may be involved in litigation matters. Some embodiments may allow, for example, such an organization to efficiently and accurately track and/or manage any or all of such litigation matters.

Moreover, as used herein, each “organization” may have one or more “sub-units” or “business groups”, “businesses”, and/or “branches”, each of which may have one or more “business segments” and operate in one or more “business regions”. As a particular example, a corporation may have a “consumer business” and a “commercial business”. The “commercial business” may have a number of business segments such as “Asset Securitization”, “Bank Loans”, “Business Credit”, “Corporate Lending”, and/or “Human Resources”. Each business (and/or each business segment) may operate in a region such as “Business Credit—Northeast US” or “Business Credit—Canada”, for example.

Some embodiments described herein are associated with a “network device”. As used herein, the phrase “network device” may refer to any device that can communicate via a network. Examples of network devices include a Personal Computer (PC), a workstation, a server, a printer, a scanner, a facsimile machine, a copier, a Personal Digital Assistant (PDA), a storage device (e.g., a disk drive), a hub, a router, a switch, and a communication device (e.g., a modem, a wireless phone, etc.). Network devices may comprise one or more network components. As used herein, the term “network component” may refer to a network device, or a component, piece, portion, or combination of network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or of any other configuration and/or type that is or becomes known. Communication networks may include, for example, one or more networks configured to operate in accordance with the Fast Ethernet LAN transmission standard 802.3-2002® published by the Institute of Electrical and Electronics Engineers (IEEE).

Further, some embodiments herein are associated with “information” or “data”. As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with one or more Internet Protocol standards, such as Internet Protocol Version 4 (IPv4) or IPv6, the latter defined by “Internet Protocol Version 6 (IPv6) Specification” RFC 1883, published by the Internet Engineering Task Force (IETF), Network Working Group, S. Deering et al., December 1995). Information may, according to some embodiments, be compressed, encrypted, and/or otherwise packaged or manipulated in accordance with any method that is or becomes known.

Some embodiments described herein are associated with “information indicative of” or “indicia” of information associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information.

### System

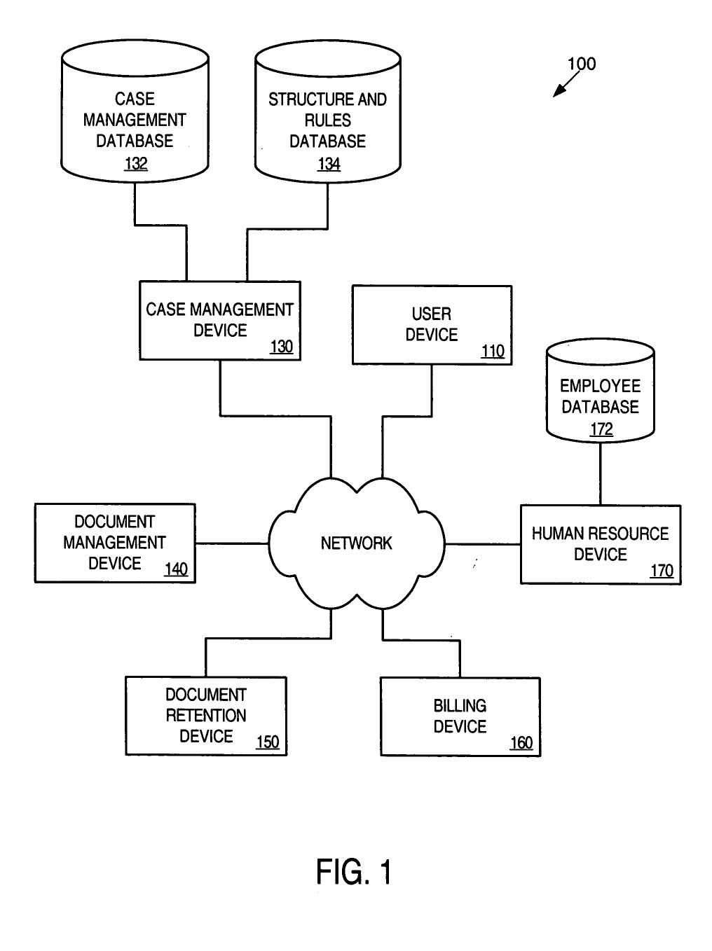

Some embodiments will now be described by first referring to FIG. 1, where a system 100 is shown. The various systems described herein are depicted for use in explanation, but not limitation, of described embodiments. Different types, layouts, quantities, and configurations of any of the systems described herein may be used without deviating from the scope of some embodiments.

According to some embodiments, the litigation management system 100 includes one or more user devices 110 in communication (e.g., via a network 120) with a case management device 130. In some embodiments, the case management device 130 may be or include and/or be in communication with a case management database 132 and/or a structure and rules database 134. According to some embodiments, the litigation management system 100 may also or alternatively include a document management device 140, a document retention device 150, a billing device 160, and/or a human resources device 170. In some embodiments, the human resource device 170 may be or include and/or be in communication with an employee database 172.

Any of the devices 110, 130, 140, 150, 160, 170 of the litigation management system 100 may be or include any type of network device (or combination of network devices) that is or becomes known. The databases 132, 134, 172 associated with the litigation management system 100 may, according to some embodiments, be or include any type of data and/or information storage structure, device, and/or medium that is or becomes known. In some embodiments, information may be stored in a single database and/or other storage device that may, for example, store the information associated with the various databases 132, 134, 172 shown in FIG. 1. In some embodiments, fewer or more devices and/or other components may be included within the litigation management system 100. Further, the network 120 and/or any other type or method of communication may link and/or associated and/or otherwise allow communication between and component of the litigation management system 100.

In some embodiments, the litigation management system 100 may include one or more networked computers configured and operated to perform the functions described herein. For example, in some embodiments, the case management device 130 may be configured to operate as a server accessible to the one or more user devices 110 over the network 120. Users operating the user devices 110 may interact, for example, with case management device 130 to enter information associated with new litigation matters, view information about existing matters, close existing matters, create reports, and/or perform other functions (e.g., as described herein).

Further, pursuant to some embodiments, certain users (such as users provided with “administrator” privileges as described elsewhere herein) may interact with the case management device 130 to establish an entity structure and establish entity litigation rules associated with the entity structure. In this manner, for example, different organizations and different businesses or other groups within the organization, may establish relevant litigation management rules allowing efficient, accurate, and timely oversight of litigation matters.

In some embodiments, the case management device 130 may interact with other sources of data and/or information. For example, the case management server 130 may interact with the human resource device 170 to access and/or utilize employee and/or other data stored within and/or by the employee database 172. In some embodiments, the case management device 130 may be used to track and manage litigation matters at a large corporation that has many employees. It can be difficult to keep track of the status, location, and contact information associated with each employee in a large corporation. Some embodiments may interface with the human resources device 170 (and/or other systems maintaining current employee information) to ensure that the case management device 130 has access to current and/or accurate employee information.

For example, the employee database 172 may store information identifying each employee's name, organization, contact information, and position. In general, as employees change positions, move within the company, or leave the company, the information is updated. This information is used for a number of purposes in some embodiments. For example, as will be discussed further below, the information is used to identify employee authority for certain actions (e.g., such as the approval of settlements). The information is also used to quickly and efficiently add employees to contact and witness lists associated with different matters. Further, the information may be used to identify and enforce access and use privileges for the litigation management system 100. In some embodiments, access and use permissions may be defined for each individual user (e.g., only selected employees may be given the ability to add or edit matter information). In some embodiments, groups, classes or organizations of users may be granted different levels of access and use privileges. For example, every employee in the “general legal” group or organization may be given the right to view selected matters. As another example, every employee in the “litigation” group (a subgroup of the “general legal” group) may be given the right to view, add and edit matters. As a further example, every employee in a “litigation tool administrator” group may be given the right to view, add, edit, close or delete matters, and may additionally be given the right to perform other administrative tasks (including, for example, the right to create “pick lists”, the right to enter and update rules, etc.). These access and use privileges may be checked each time a user attempts an action (e.g., if a user attempts to edit matter information, the litigation management system may determine if the user has sufficient access privileges prior to permitting the action).

As another example, the case management device 130 may interact with the billing device 160 to ensure that third party service providers associated with litigation matters are paid. For example, the billing device 160 may be or include an organization's accounts payable system. In some embodiments, each litigation matter may be established with one or more billing identifiers. In some embodiments, the billing identifier may be used to track individual matters. In other embodiments, a file number or other identifier may be utilized.

As still another example, the case management device 130 may interact with the document management device 140 to provide standardized document formats and/or to create a centralized repository of documents that are associated with matters tracked in and/or by the case management device 130. For example, the document management device 140 may store settlement agreements, pleadings, briefs, and/or other documents or information associated with the case management device 130.

As another example, the case management device 130 may also or alternatively interact with the document retention device 150 to ensure that document retention procedures are appropriately followed and/or to create a readily accessible collection of documents associated with each litigation matter tracked by the case management device 130. In some embodiments, the litigation management system 100 may be operated to initiate document retention policies once a new litigation matter is opened. For example, a document retention letter may be automatically distributed to employees who are associated with a newly created matter. Other segments, components, and/or devices may interface with the case management device 130 without deviating from the scope of some embodiments.

According to some embodiments, the case management device 130 may transmit (and/or receive) information to (and/or from) different devices via different networks. For example, in some embodiments, the litigation management system 100 may be operated by an organization which includes a number of different businesses, some or all of which may be geographically separate. In such an organization, for example, the case management device 130 may communicate with user devices 110 (and/or other devices) operated by users at different business locations over separate networks (e.g., the network 120 may be or include one or more separate and/or distinct networks and/or network types). Although only a single case management device 130 is shown, multiple case management devices 130 may, according to some embodiments, be provided for an organization. In some embodiments, different organizations may have access to the same case management device 130 (which may be configured with appropriate security and privacy protection to ensure that case management data of each organization is appropriately guarded).

The case management device 130 and/or each of the other devices 110, 140, 150, 160, 170 may be or include any devices capable of performing the various functions described herein. The case management device 130 may be, for example, a Web server. According to some embodiments, the user device 110 may be a PC capable of running a Web browser, such as the INTERNET EXPLORER® 4.0/5.0/6.0 Web browser available from MICROSOFT CORP.®, allowing a user to direct the Web browser to interact with Web pages hosted by, for example, the case management device 130. A number of illustrative user interfaces that may be used in conjunction with some embodiments will be discussed below in conjunction with FIG. 9.

### Structure Definition Method

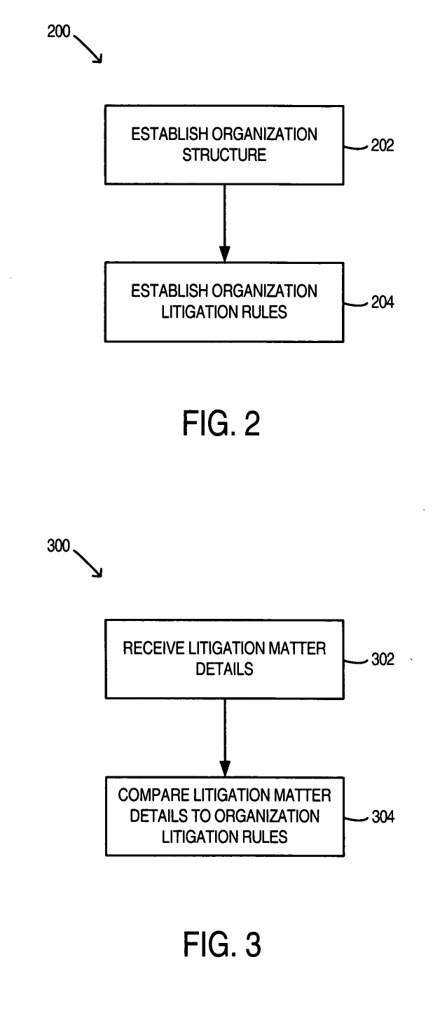

Turning now to FIG. 2, a flow diagram of a method 200 according to some embodiments is shown. In some embodiments, the method 200 may be conducted by and/or by utilizing the litigation management system 100 described above and/or may be otherwise associated with the litigation management system 100 or any of the system components described in conjunction with FIG. 1 above. In some embodiments for example, the method 200 may be performed by, on, and/or within the case management device 130. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

The method 200 is a process that may be performed, according to some embodiments, by the case management device 130 to create a new organizational structure (or modify or update an existing structure) and/or to create (or modify or update) litigation rules associated with an organization or businesses of the organization. Processing may begin, for example, at 202 to establish or otherwise define an organization structure so that litigation matters of the organization may be managed in an automated or semi-automated manner using the litigation management system 100. In some embodiments, the organization structure may be established for an organization utilizing and/or otherwise associated with the case management device 130. According to some embodiments, a user (e.g., operating a user device 110) may enter information that is used, at least in part, to establish the organization structure. For example, in the example introduced above, processing at 202 may involve entering data and information identifying the organization structure that includes two businesses (e.g., the “commercial business” and the “consumer business”), each of which may have multiple business segments and operate in different business regions.

In some embodiments, data entry (at 202 and in other interactions with the system 100) may be facilitated through the use of “pick lists” or other Graphical User Interface (GUI) tools allowing a user to easily specify information. At 202 the pick lists may assist a user in entering information to define an organization structure. In some embodiments, processing at 202 may also include the creation of new pick lists by authorized users. For example, data entered at 202 may be stored in one or more databases (e.g., such as databases 132, 134, 172). The data may be used to generate one or more pick lists that may be used to facilitate data entry when information is entered defining litigation matters associated with the businesses. For example, the pick lists may allow users to quickly and accurately enter information associated with a particular business, segment, and/or region. Data entered may also or alternatively include data used to associate information from the employee database 172 with the business structure (e.g., information may be entered which associates groups of employees with particular businesses, segments or regions).

In some embodiments, the method 200 may continue at 204 to establish organization litigation rules. For example, a user operating a user device 110 may enter information establishing one or more litigation rules associated with the organization. In some embodiments, a hierarchy of litigation rules may be identified, provided, and/or otherwise established. For example, a top-level set of rules may be established which apply to all businesses within the organization. In some embodiments, if a total exposure amount is so large that it would be considered a “material” item requiring public disclosure or other treatment, an organization-wide rule may be defined which requires immediate reporting to the General Counsel (GC) as well as other individuals in upper management.

Additional rules may be specified and/or established which apply to individual businesses. For example, additional rules may include rules that define specific notification requirements associated with different types of matters. As a specific example, when information is entered regarding a new matter that involves a trade secret or a patent dispute, a business may specify that the Chief Intellectual Property Officer of the business be notified as well as the business' GC. Other rules may be established to allow information to be efficiently shared with relevant individuals and groups. Still other rules may be specified which relate to approval authorities. For example, a business may specify that matters that involve certain types of settlements or resolutions need particular approvals (e.g., a business may indicate that settlements of greater than $50 Million must be approved by the CEO, the CFO and the GC of the business).

Once an organization and/or each business has established a structure and defined litigation rules the case management device 130 may be made available for data entry. In some embodiments, the method 200 may be updated, repeated, and/or performed on a regular (or other) basis as the business changes and as different rules are implemented. In some embodiments, a central service and/or other entity (e.g., that operates and/or owns the litigation management system 100) may perform the method 200 and/or either of the processes 202, 204 associated therewith.

### Data Entry Method

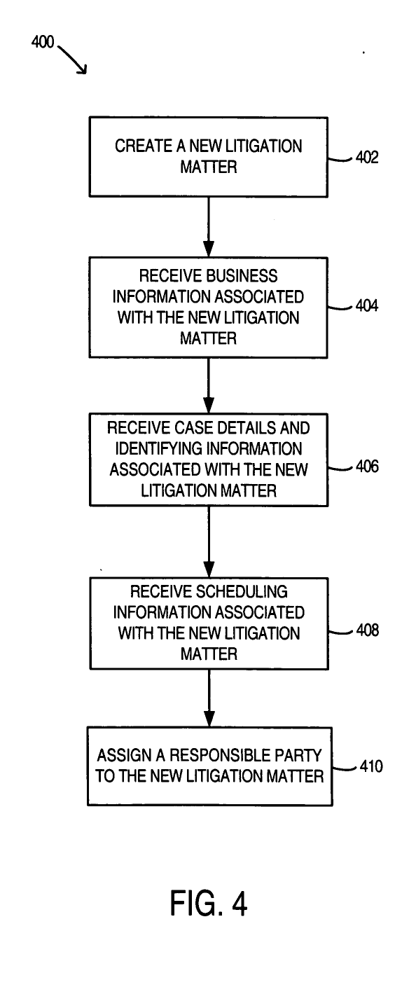

Referring now to FIG. 3, a flow diagram of a method 300 according to some embodiments is shown. In some embodiments, the method 300 may be conducted by and/or by utilizing the litigation management system 100 described above and/or may be otherwise associated with the litigation management system 100 and/or any of the system components described in conjunction with FIG. 1 above. In some embodiments for example, the method 200 may be performed by, on, and/or within the case management device 130. In some embodiments, the method 300 may be a continuation and/or a component of the method 200 described above.

For example, the method 300 may begin at 302 to receive litigation matter details. In some embodiments, the method 200 may, for example, have been already performed and/or initiated (e.g., via an organization and/or central service). According to some embodiments, the information received at 302 may be or include information received via data entry (e.g., from a user device 110). Litigation and/or other matter details may, according to some embodiments, be entered by one or more authorized users by interacting with the case management device 130 through a user device 110. Matter details may be entered in an initial matter creation process, during the pendancy of the matter, and/or when the matter is closed.

Each time data is entered regarding a matter (e.g., at 302), processing may proceed to 304 to compare litigation matter details to organization litigation rules. In some embodiments, the comparing may be performed, for example, to identify notifications and/or other actions that should be initiated. This comparison may be performed to ensure that the rules are complied with and that any notifications or other actions are taken by the system. For example, if the data entry (e.g., at 302) includes opening a new matter having a large potential dollar amount at risk, notifications to appropriate parties may be automatically generated based on the comparison at 304. In some embodiments, the organization litigation rules compared at 304 may be or include the organization litigation rules established at 204 in method 200 described above.

### New Matter Method

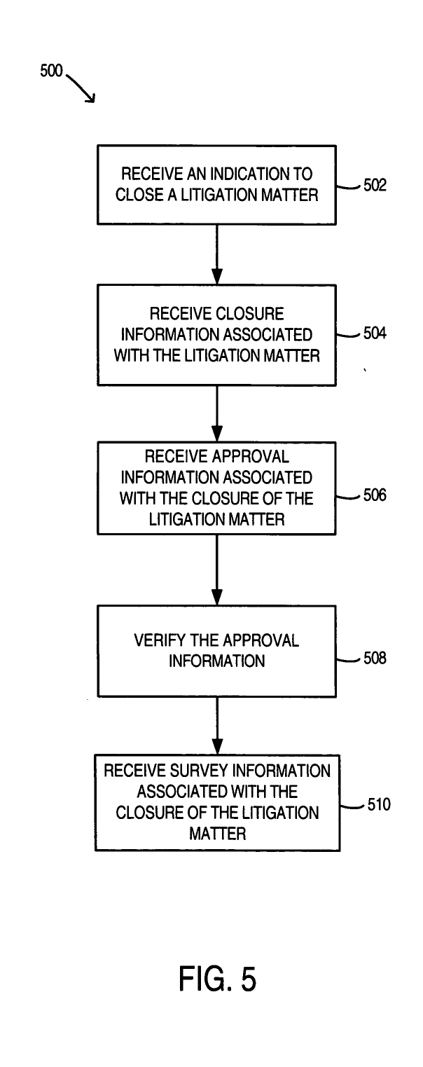

Reference is now made to FIG. 4, where a flow diagram of a method 400 according to some embodiments is shown. In some embodiments, the method 400 may be conducted by and/or by utilizing the litigation management system 100 described above and/or may be otherwise associated with the litigation management system 100 and/or any of the system components described in conjunction with FIG. 1 above. In some embodiments for example, the method 400 may be performed by, on, and/or within the case management device 130. In some embodiments, the method 400 may be a continuation and/or a component of and/or otherwise associated with any of the methods 200, 300 described above. The method 400 may, for example, be or include the process 302 described in conjunction with FIG. 3 above. In some embodiments, the method 400 may occur and/or be performed anytime a new matter arises. Further, the method 400 may be performed under the direction or control of an authorized user.

Processing may begin, according to some embodiments, at 402, to create a new matter. In some embodiments, a request to create a new matter may be received, from a user for example. In some embodiments, only certain authorized users may create a new matter. User interfaces may be presented to the user that may, for example, prompt the user to enter information. The method 400 may continue at 404 where business information associated with the new litigation matter is received. The business information may include, for example, business information relating to, involved with, important to, and/or otherwise associated with the litigation matter. In some embodiments, the method 400 may continue at 406 to receive case details and identifying information associated with the new litigation matter. For example information including case information and other identifying details may be received from a user. According to some embodiments, the method 400 may also or alternatively receive scheduling data associated with the new litigation matter, at 408. For example, the scheduling information may include information such as scheduling, timing, and/or other date or calendar information associated with the new litigation matter (and/or relating to existing litigation matters).

At 410, the method 400 may continue to assign a responsible party to the new litigation matter. For example, a responsible party such as a corporate officer, executive, and or legal representative may be assigned to the new litigation matter. According to some embodiments, the assignment of the responsible party may include identifying privileges to be associated with the responsible party. For example, the responsible party may have full access to and/or control over the litigation matter, and/or may be limited to certain necessary functionalities. In some embodiments, only certain users (e.g., such as users having “administrator” privileges or designated or assigned responsible parties) may assign or identify responsibilities and privileges. This information may be stored for use and/or reference (e.g., in a database such as those described in conjunction with FIG. 1).

### Closing a Matter Method

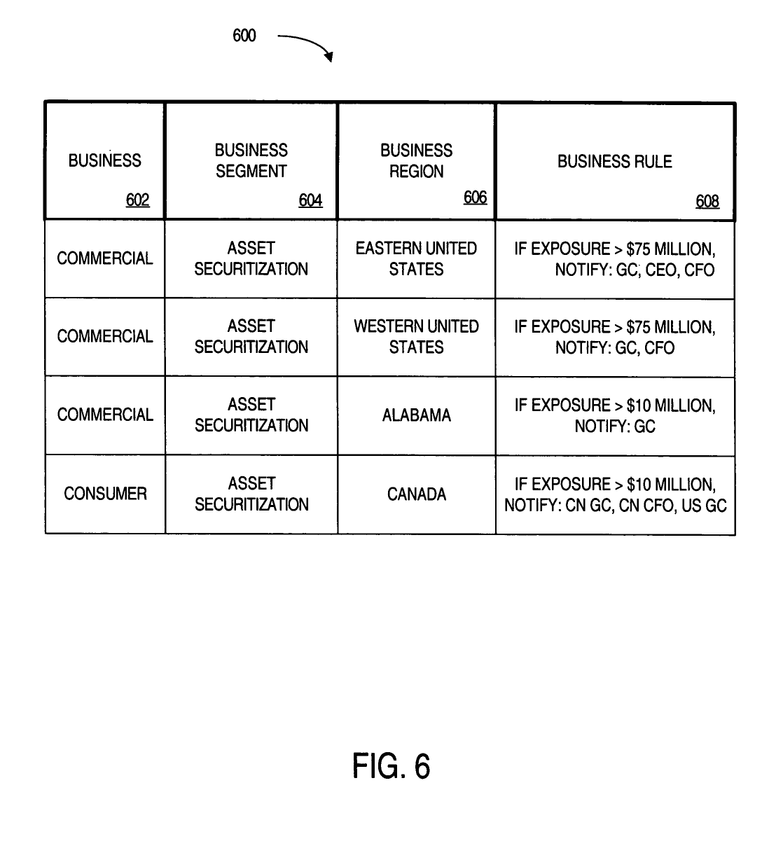

Reference is now made to FIG. 5, where a flow diagram of a method 500 according to some embodiments is shown. In some embodiments, the method 500 may be conducted by and/or by utilizing the litigation management system 100 described above and/or may be otherwise associated with the litigation management system 100 and/or any of the system components described in conjunction with FIG. 1 above. In some embodiments for example, the method 500 may be performed by, on, and/or within the case management device 130. In some embodiments, the method 500 may be a continuation and/or a component of and/or otherwise associated with any of the methods 200, 300, 400 described above.

The method 500 may be performed, according to some embodiments, each time a matter tracked, stored, and/or managed by litigation management system 100 is closed. Processing may begin at 502 to receive an indication to close a matter. In some embodiments, the indication may include a request, such as a request from a user. The request to close the selected litigation matter may, according to some embodiments, be identified and/or otherwise determined. The method 500 may continue at 504 to receive closure information associated with the litigation matter. In some embodiments, the closure information may include information such as settlement information (e.g., information associated with the settlement of the litigation matter). Information regarding the closure and/or settlement of the litigation matter may, for example, be provided by a user operating a user device 110. The information may include, for example, information regarding the nature of the settlement or closure of the litigation matter. The method 500 may continue at 506 to receive approval information associated with the litigation matter. For example, the approval information may include information identifying the individual who authorized (or needs to authorize) the closure of the litigation matter.

Processing may continue, according to some embodiments, at 508 to verify the approval information. For example, the verification may include contacting the necessary individual or individuals via e-mail or other means and/or by confirming the business rules for the business to verify that the identified individual has authority to authorize closure of the matter. In some embodiments, processing may continue at 510 to receive survey information associated with the closure of the litigation matter. The survey information may include, for example, an assessment of outside counsel, an assessment of a witness, mediator, judge, or other entity involved in the matter. In this manner for example, current information may be captured for sharing with other businesses in the organization.

### Exemplary Database Entries

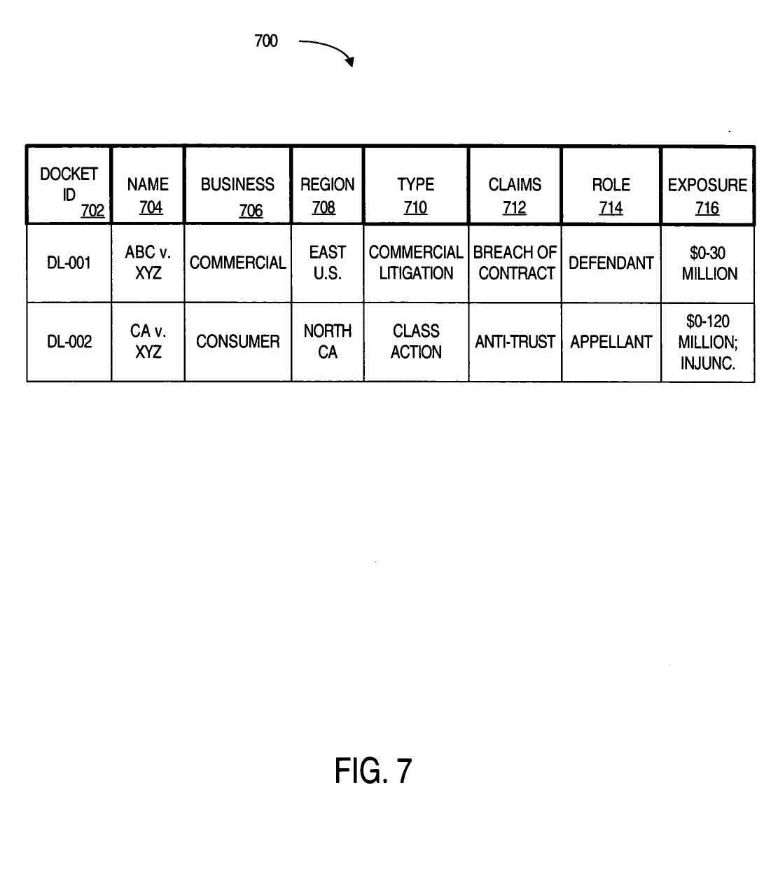

Referring now to FIG. 6, a diagram of a portion of a database table 600 according to some embodiments is shown. The database table 600 may, according to some embodiments, represent, be, and/or include a table representing a database such as the structure and rules database 134 that may be stored at (or accessible to) the case management device 130. As shown, the database table 600 may include entries identifying a structure of an organization operating the case management device 130 and entries identifying litigation rules established by the organization (and/or by sub-units of the organization). Some and/or all of the information in the entries may, according to some embodiments, be entered by authorized users operating user devices 110.

The database table 600 may, for example, define a number of fields for each of the entries (e.g., shown as fields 602, 604, 606, 608 but containing more or fewer as needed). The fields shown specify: a business 602, a business segment 604, a business region 606, and a business rule 608. In some embodiments, many, multiple, and/or additional or alternative business rules and/or business rule fields 608 may be included in the database table 600 as is or becomes practicable. In the database table 600 shown in FIG. 6, only a portion of a database is necessarily shown, specifying some of the businesses, segments and regions associated with a particular organization. Several example rules are shown as well. Other database fields, columns, structures, quantities, and/or configurations may be utilized without deviating from some embodiments.

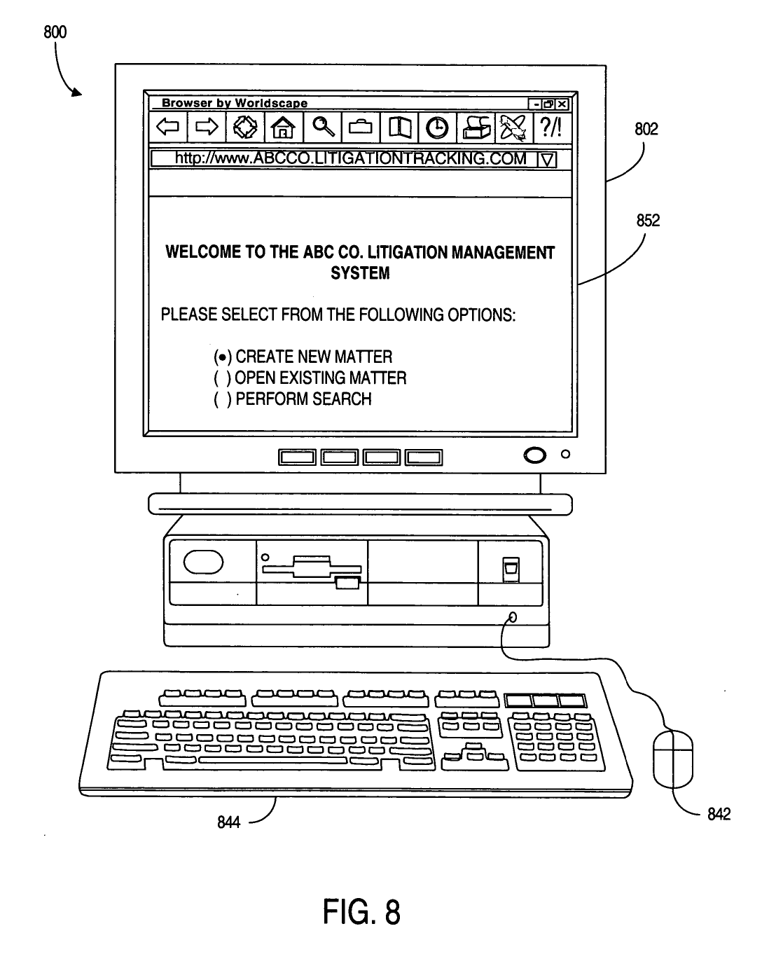

Referring to FIG. 7, a diagram of a portion of a database table 700 according to some embodiments is shown. The database table 700 may, for example, represent a database such as the case management database 132 that may be stored at (or accessible to) the case management device 130, according to some embodiments. The database table 700 may, according to some embodiments, include entries identifying specific litigation matters that have been opened using the litigation management system 100. Information may be received, for example, from authorized users operating user devices 110.

Various quantities, types, and/or configurations of fields may be provided to track and/or manage litigation matter information. A number of exemplary fields 702, 704, 706, 708, 710, 712, 714, 716, are shown in FIG. 7 for illustrative purposes. For example, the docket id field 702 may be or include a numerical (and/or other) identifier that uniquely identifies a particular litigation and/or other matter. The other fields of the database table 700 may generally contain information relating to various attributes and/or other information associated with various litigation and/or other matters (e.g., as shown in FIG. 7).

### Exemplary User Device

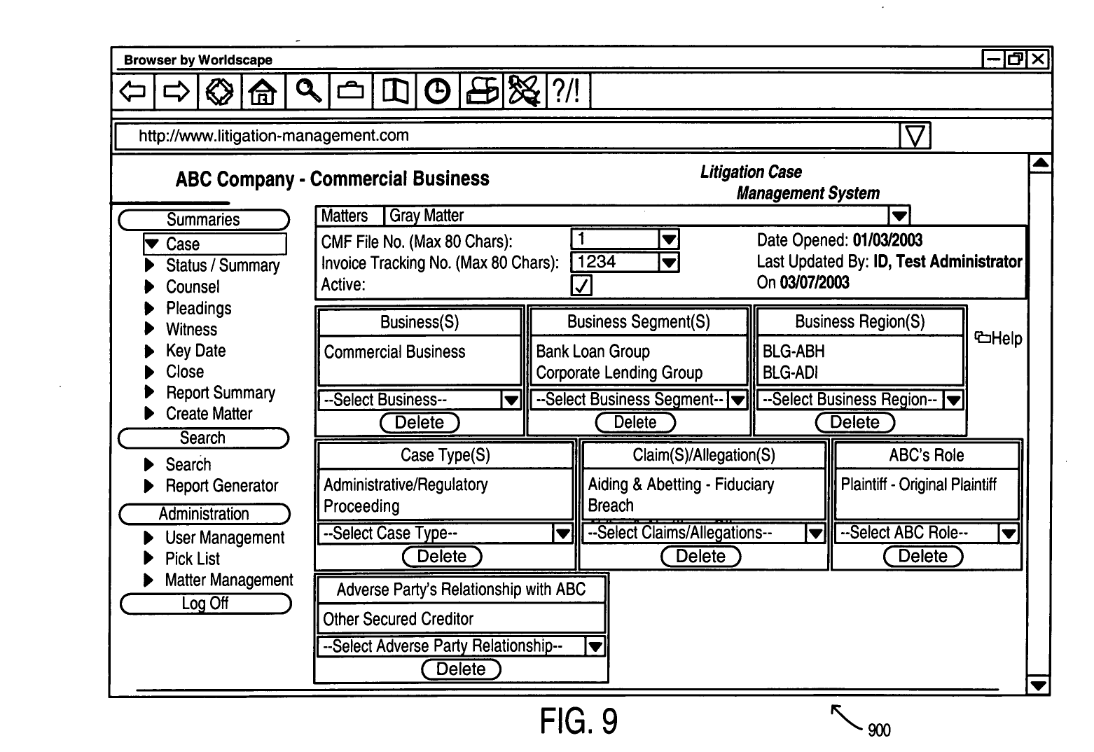

In FIG. 8, a block diagram of a device 800 according to some embodiments is shown. As discussed above, users may interact with the case management device 130 using user devices 110. The device 800 may, according to some embodiments, be or include a user device 110. In some embodiments, the device 800 may include a display 802. The display 802 may, for example, display a user interface 852. According to some embodiments, the user device 800 may also or alternatively include one or more input devices such as a mouse 842 and/or a keyboard 844 (e.g., for interacting with the litigation management system 100). In the example user interface 852 depicted in FIG. 8, a simple menu is displayed allowing a user to select one of several options, including the creation of a new matter (e.g., which may result in performance of a process such as in accordance with the method 400 described above), opening an existing matter, and/or performing searches (e.g., for information associated with particular matters and/or types of matters).

### Exemplary User Interface

Reference is now made to FIG. 9, where an exemplary screen display 900 according to some embodiments is shown. In some embodiments, the screen display 900 may be or include an interface which may be displayed, for example, to facilitate the opening and/or creation of a litigation matter in accordance with the method 400 described above. In some embodiments, the screen display 900 may be associated with any of the methods 200, 300, 400, 500 and/or with the litigation management system 100 as described herein. The screen display may include, according to some embodiments, various fields such as are shown in FIG. 9. For example, the fields of the screen display 900 may allow a user to search for, create, modify, and/or otherwise retrieve and/or provide information associated with litigation and/or other matters. Other types, quantities, and/or configurations or layouts of screen displays 900 may be used without deviating from some embodiments. For example, the case management device 130 of the litigation management system 100 may provide and/or serve multiple web pages through which users may manage litigation information. In the user interface shown in FIG. 9, a user is presented with a number of navigation options. For example, on the left-hand side of the interface, a number of “summary” pages may be viewed, showing an authorized user information regarding the case, a status/summary of the case, the counsel associated with the case, case pleadings, witnesses, key dates, etc. Some of this information may be entered by authorized users; other information may be automatically retrieved from one or more sources (e.g., some witness information may be pulled from the employee database for employee witnesses). Other pages may also be viewed, including search pages (allowing authorized users to search across open or closed matters) and report pages (allowing authorized users to create various reports including information retrieved from open or closed matters). Users having administrative privileges may access other pages, including pages for user management (e.g., allowing the granting or changing of access permissions), pick list management (e.g., allowing the creation or modification of pick lists), and other matter management functions.

The right-hand side of the user interface of FIG. 9 shows a case summary screen for a matter opened on Jan. 03, 2003. An audit trail shows which user performed the most recent update as well as the date of the most recent update. In some embodiments, these fields may not be edited or changed. The summary screen shows that the matter is active and is associated with the commercial business of ABC Corp. Pursuant to some embodiments, the “active” or “inactive” status may only be changed by authorized users and pursuant to any rules in force for the matter. In some embodiments color coding may be used to further distinguish between different statuses or types of information.

As shown, a pick list is provided to allow an authorized user to select among the recognized businesses of ABC Corp. (e.g., in this example, the pick list may offer two selections: commercial and consumer). The screen further allows a user to identify the business segment(s) and region(s) impacted by the matter (again, selections may be made via pick lists). As shown, pick lists may also be used to enter information identifying the matter type, the claims or allegations therein, ABC's role in the litigation, and the adverse party's relationship with ABC (if any). Through use of pick lists and structured data entry forms, the information provided by different users is standardized, thereby allowing ready searching and reporting.

A number of other data entry screens may be provided using common Web or interface techniques. Several of the screens will now be described in general terms to provide further example information regarding various embodiments. Those skilled in the art will recognize that other screens, collections of data, and data entry techniques may be used.

Different status or summary screens may be used. Some or all of the screens may use pick lists (if appropriate) or data entry screens. For example, screens may be provided which allow the selection or display of one or more “case assessment forms”, insurance coverage status information (including the insuring company), the court type, the court name, the judge or arbitrator, an individual identified as the key business contact (e.g., an organization employee whose information is retrieved from the employee database), a currency unit (identifying the base currency associated with the matter's jurisdiction), and an exposure range (including from, to, paid settlement, received settlement and reserve subfields which may be automatically formatted pursuant to the currency unit). As mentioned above, litigation rules may be applied to data entered in some of these fields to ensure that appropriate reporting is performed.

Other screens may allow authorized users to enter, edit or view (as appropriate and as authorized) counsel data associated with a matter. For example, authorized users may enter, edit or view data associated with the opposing counsel (the information may be selected via a pick list if information regarding the opposing counsel was previously entered for another matter, otherwise the information is newly entered and may be available as a pick list for future matters) and outside counsel (again, if the outside counsel information was previously entered, it may be selected via a pick list, otherwise the information is newly entered and may be available as a pick list for future matters).

Other screens may allow authorized users to enter, edit or view (as appropriate and as authorized) pleadings summaries associated with a matter. For example, information associated with a caption of the matter may be entered. A matter may have multiple captions, each associated with multiple pleadings. An authorized user can add a new caption or edit existing captions. New pleadings can be added to the caption or the existing ones can be edited (or deleted). Each caption will be include information identifying the court, the court type, the judge(s) and information about the caption and the docket number. An authorized user can add new judges and courts to the system and can also add pleadings to a caption. The user can add multiple pleadings with information such as a tab number, date, party and description to facilitate easy retrieval and viewing. The user may also create an updated docket listing based on the pleadings list, thereby allowing others to quickly view the status of the matter.

Other screens may allow authorized users to enter, edit or view (as appropriate and as authorized) witness information associated with a matter. For example, a screen may be presented having checkboxes next to existing witnesses (allowing an authorized user to remove witnesses from the matter). Pick lists and other lists of witnesses may also be provided to make it easy to add witnesses. Search mechanisms may be provided to quickly search the employee database for a desired witness to add the witness to the list. In some embodiments, screens may be provided which list details associated with all of the witnesses assigned to a matter, including information designating whether a particular witness is a “key player” or key witness. Other information may be provided including information designating whether any action items are due associated with the witness (as well as details regarding the item). Still other information may be provided to identify contact information, who referred the witness, the relevant position of the witness in the matter, a list of document(s) produced, the witness' role in the matter, etc. Further screens may be provided to cross reference the witness between matters (e.g., a screen may show a list of matters in which the witness is involved and a list of the items assigned to the witness). Non employee witnesses may be added through a data entry screen (if the non-employee witness information was previously entered, it may be selected via a pick list, otherwise the information is newly entered and may be available via a pick list for future matters).

Other screens may allow authorized users to enter, edit or view (as appropriate and as authorized) “key date” information associated with a matter. For example, key dates may be any date that is important to the matter. These dates may be used by the system to generate notices, reminders and other information for users assigned to the matter. Key date information may be entered by authorized users via a data entry screen which may require a user to enter information such as a description of the event, the date, a warning or reminder date(s), a warning or reminder message(s), the date the event is created, the name of the person submitting the event, etc. Reminders may be automatically emailed by the system on the warning or reminder date(s). In some embodiments, “key dates” and other reminders may be displayed in a calendar form. In some embodiments, dates and reminders may be published in or integrated with existing calendaring systems. As an illustrative example, in some embodiments, dates and reminders generated by the system are integrated into Microsoft Outlook® (e.g., dates may be calendared in a user's Outlook® calendar and reminders may be sent to users via Outlook® e-mail).

A number of screens may be available only to administrators, allowing them to manage access permissions and user privileges. In some embodiments, entire groups of employees may be given certain access privileges (e.g., the “litigation group” may be given edit and view privileges). In some embodiments, individual employees are selected to have particular access privileges. Administrators may also be allowed to create new matters and assign employees to the matter. A matter created by an administrator may automatically be created in the “active” state, while a matter created by a “litigation group member” may be created in an “inactive state” and must be approved by an administrator before it becomes “active”. As discussed above, rules and controls may be imposed to ensure that a matter in the “active” state is only switched to “inactive” if the relevant rules are complied with (e.g., including ensuring that the appropriate approval authorities have authorized the closure of the matter). Administrators may also be given the ability and the authority to delete matters.

As discussed above, administrators may also have access to screens allowing the creation or editing of pick lists. In general, pick lists are master data of the system. This information is available to all the users across all the groups. An administrator may access a pick list editing screen which, for example, displays the existing pick list data in tabular format. For example, each pick list item may have a name and a description and may be associated with a more detailed screen that allows data to be edited. An administrator may also delete an item from a pick list; however, if the item is currently in use in any active or inactive matter (or any matter marked for deletion), the system will not allow the item to be deleted.

A number of pick lists may be used to manage data and control data entry, including as examples the following types of pick lists: product (listing products manufactured by the company; case type (listing types of matters), organization businesses (listing the various organization businesses); adverse party's relationship with the organization (listing a number of types of relationships that opposing parties may hold with the organization); group (a listing of groups that are assigned to matters, e.g., to signify the different kinds of matters); insurance status (listing of the various applicable insurance statuses such as “uninsured”, “insurance by other” etc.); subfolder (listing the various subfolders available for use in performing file updates); court type (listing the various court types, such as “state court” or “local court”, etc.); claims/allegations (listing various applicable claims and allegation types); organization role (listing various organization roles); standard links (holding a list of links to be shown in a summary section of all the matters. They contain URL information including an address and name); user group (identifying separate groups of an organization); courts (listing names of various courts to be added to pleadings); judges (listing names of judges); etc.

Other screens may be provided to facilitate searches. For example, a search module may be accessible to authorized users, allowing searches to be performed on active or inactive matters. For example, a screen may be provided allowing a user to search by selecting the whether to search across active matters, inactive matters or all matters. The user may also enter a particular file number and run a search. Similarly a user may search on a matter name only. In some embodiments, a user may search in at least three different ways using the same searchable text. As an example, if the search string “John Smith” is entered, several different searches may be performed:

1. To search on full searchable string, the user selects ‘Search on Exact String’ (default). In this case, search will be done across all the matters containing the word ‘John Smith’.

2. To search for the presence of each word entered as searchable string, the user selects ‘Search on any word’. In this case, the search will identify all the matters containing the word ‘John’ or ‘Smith’.

3. To search for the presence of each word entered as searchable string in combination, click on ‘Search on each word’. In this case, the search will identify all the matters containing the word ‘John’ and ‘Smith’.

For each of the searches, the system will search in fields including: the matter summary, the matter status, the strategy field, the outside counsel and opposing counsel, notes, plaintiffs, defendants, insurance company information, and procedural history.

Still other screens may allow authorized users to generate a variety of reports. In some embodiments, the screens may allow the user to select different fields to search to identify all matters satisfying the search request. A screen may display all the matters satisfying the search and allow the user to select among the matters to generate reports. Authorized users may print the list of matters or certain matters in the list. Different reports may be generated, including matter details, etc. Those skilled in the art, upon reading this disclosure, will recognize that a number of other screens and data entry techniques may be used in conjunction with the present invention.

### Exemplary Case Management Device

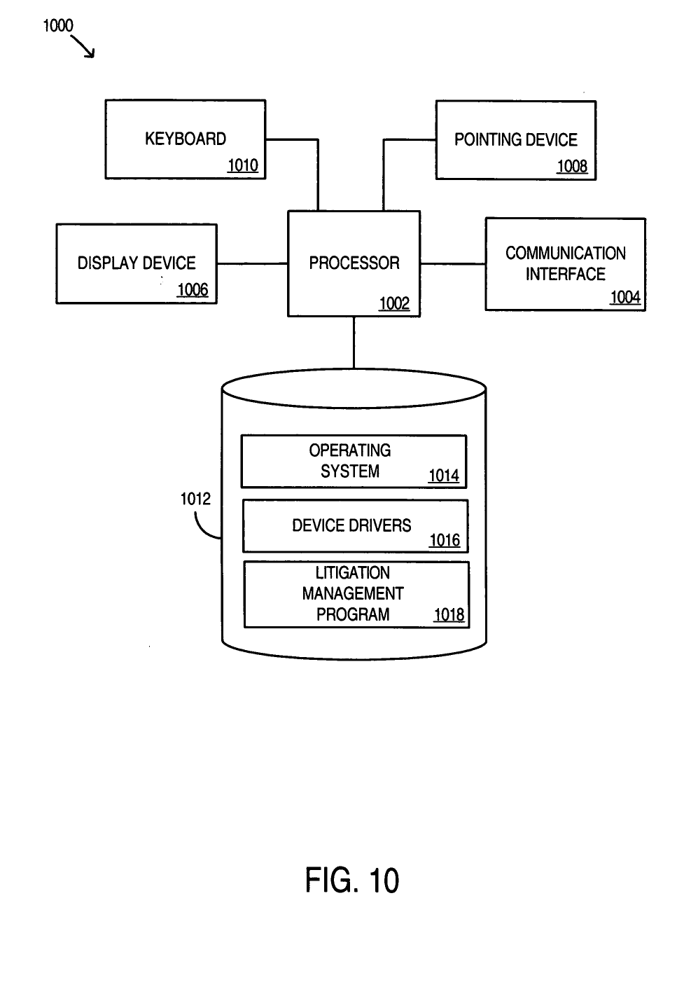

Turning now to FIG. 10, a block diagram of an apparatus 1000 according to some embodiments is shown. The apparatus 1000 may, for example, be or include a network device. In some embodiments, the apparatus 1000 may be or include a device and/or multiple devices within the litigation management system 100 described herein. The apparatus 1000 may, for example, be a case management device 130.

In some embodiments, the apparatus 1000 may include a processor 1002, a communication interface 1004, a display device 1006, a pointing device 1008, a keyboard 1010, and/or a storage device 1012. According to some embodiments, the processor 1002 may run an operating system 1014, operate device drivers 1016, and/or run programs such as a litigation management program 1018. Any or all of the operating system 1014, the device drivers 1016, and/or the litigation management program 1018 may be stored, for example, on and/or by the storage device 1012.

According to some embodiments, the operation and/or execution of the litigation management program 1018 may cause the apparatus 1000 to operate in accordance with any of the methods 200, 300, 400, 500 and/or any of the embodiments described herein. In some embodiments for example, the apparatus may be the case management device 130 and may communicate with a user device 110 (e.g., via the communication interface 1104) and/or display a user interface such as the screen display 900 (e.g., using the display device 1006).

Although embodiments of the present invention have been described with respect to particular types of organizations, the present invention can be used with any type of organization. For example, the present invention may be used to acquire information for a trade association or a government agency that has a number of units.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A litigation management method, comprising:
receiving information associated with a structure of an organization;
receiving information associated with a litigation rule of the organization;
receiving information associated with a litigation matter; and
comparing the information associated with the litigation matter with the information associated with the structure and the litigation rule to identify an action to be taken.

2. The method of claim 1, wherein the information associated with the structure of the organization is indicative of a plurality of businesses associated with the organization.

3. The method of claim 2, wherein the information associated with the litigation rule of the organization includes information indicative of one or more litigation rules associated with each of the plurality of businesses.

4. The method of claim 1, wherein the information associated with the structure of the organization includes information indicative of one or more employees associated with the organization.

5. The method of claim 1, wherein the information associated with the litigation rule of the organization includes information indicative of notification procedure to be commenced upon the occurrence of one or more events.

6. The method of claim 1, wherein the information associated with the litigation rule of the organization includes information indicative of an approval required prior to undertaking one or more events.

7. The method of claim 1, wherein the information associated with the litigation rule of the organization includes information indicative of an information sharing procedure.

8. A method, comprising:
receiving information associated with a litigation matter;
comparing the information to one or more litigation rules associated with an organization; and
determining whether the one or more litigation rules require an action to be taken with respect to the information associated with the litigation matter.

9. The method of claim 8, further comprising:
causing the action to be taken if required by the one or more litigation rules.

10. The method of claim 9, wherein the action includes at least one of a notification, an approval, or a sharing of information.

11. The method of claim 8, further comprising:
creating a record identifying the individual providing the information.

12. A method, comprising:
receiving a request to create a new litigation matter;
receiving (i) business identification information, (ii) case detail information and (iii) scheduling information, each of the received information types being associated with the new litigation matter;
assigning at least one of a responsibility and a privilege associated with the new litigation matter; and
providing information indicative of the creation of the new litigation matter.

13. The method of claim 12, further comprising:
storing at least one of the received information types in a database.

14. The method of claim 12, wherein the request is received from a user interface.

15. The method of claim 14, wherein the user interface includes a plurality of input screens each having a plurality of data input fields, wherein at least one of the plurality of data input fields has an associated rule allowing data entry or modification by individuals having a designated assigned privilege.

16. A method, comprising:
receiving a request to close a litigation matter;
receiving at least one of settlement and closure information associated with the litigation matter;
receiving information associated with an approval to close the litigation matter;
verifying the received approval; and
providing information indicative of the closure of the litigation matter.

17. The method of claim 16, further comprising:
receiving survey information associated with the closure of the litigation matter.

18. The method of claim 17, wherein the survey information includes information indicative of an assessment associated with the closure of the litigation matter.

19. The method of claim 17, wherein the survey information includes information relating to at least one of an outside counsel associated with the litigation matter, a witness associated with the litigation matter, a mediator associated with the litigation matter, or a judge associated with the litigation matter.

20. The method of claim 18, wherein the information associated with the approval of the closure includes information identifying at least one entity that authorized the closure.

21. The method of claim 20, wherein the at least one entity includes an employee of an organization associated with the litigation matter.

22. The method of claim 16, wherein the verification of the approval includes contacting an entity that authorized the closure of the litigation matter.

23. The method of claim 20, wherein the verification of the approval includes confirming that an entity that authorized the closure of the litigation matter has authority to authorize the closure.

24. A litigation management system, comprising:
a processor; and
a storage device in communication with the processor and storing instructions adapted to be executed by the processor to:
receive first information associated with a structure of an organization;
receive second information associated with a litigation rule of the organization;
receive third information associated with a litigation matter; and
compare the second information and the third information to identify an action to be taken.

25. A litigation management system, comprising:
a processor; and
a storage device in communication with the processor and storing instructions adapted to be executed by the processor to:
receive a request to create a new litigation matter;
receive (i) business identification information, (ii) case detail information and (iii) scheduling information, each of the received information types being associated with the new litigation matter;
assign at least one of a responsibility and a privilege associated with the new litigation matter; and
provide information indicative of the creation of the new litigation matter.

26. A litigation management system, comprising:
a processor; and
a storage device in communication with the processor and storing instructions adapted to be executed by the processor to:
receive a request to close a litigation matter;
receive at least one of settlement and closure information associated with the litigation matter;
receive information associated with an approval to close the litigation matter;
verify the received approval; and
provide information indicative of the closure of the litigation matter.

27. A litigation management system, comprising:
a processor; and
a storage device in communication with the processor and storing instructions adapted to be executed by the processor to:
receive first information associated with a litigation matter;
identify at least one business rule associated with the litigation matter; and
generate at least a first notification based on a comparison of the at least one business rule and the first information.

28. A computer-readable medium having computer executable software code stored therein, the code comprising:
code to receive first information associated with a structure of an organization;
code to receive second information associated with a litigation rule of the organization;
code to receive third information associated with a litigation matter; and
code to compare the second information and the third information to identify an action to be taken.

29. A computer-readable medium having computer executable software code stored therein, the code comprising:
code to receive a request to create a new litigation matter;
code to receive (i) business identification information, (ii) case detail information and (iii) scheduling information, each of the received information types being associated with the new litigation matter;
code to assign at least one of a responsibility and a privilege associated with the new litigation matter; and
code to provide information indicative of the creation of the new litigation matter.

30. A computer-readable medium having computer executable software code stored therein, the code comprising:
code to receive a request to close a litigation matter;
code to receive at least one of settlement and closure information associated with the litigation matter;
code to receive information associated with an approval to close the litigation matter;
code to verify the received approval; and
code to provide information indicative of the closure of the litigation matter.

31. A computer-readable medium having computer executable software code stored therein, the code comprising:
code to receive first information associated with a litigation matter;
code to identify at least one business rule associated with the litigation matter; and
code to generate at least a first notification based on a comparison of the at least one business rule and the first information.

32. A matter management system, comprising:
a processor;
a communication device in communication with the processor and an employee database system; and
a storage device in communication with the processor and storing instructions adapted to be executed by the processor to:
identify a matter having an action date;
identify at least a first rule associated with the matter, the first rule identifying at least a first employee associated with the matter; and
using information from the employee database system, communicating information about the action date and the matter to the at least first employee.

33. The matter management system of claim 32, wherein the information about the action date and the matter are communicated using at least one of an electronic mail message or a calendar entry.

34. The matter management system of claim 32, the processor further storing instructions adapted to be executed by the processor to:
identify a request to add a witness to the matter;
determine that the witness is an employee in the employee database system; and
automatically add information associated with the witness to the matter.

35. A method for configuring a litigation management system, the litigation management system having at least a first pick list defining a set of actions and information associated with at least a first litigation matter, the method comprising:
receiving a request from an individual to perform an action, the action including at least (i) a request to close the at least first litigation matter; (ii) a request to delete the at least first litigation matter; (iii) a request to edit said at least first pick list; or (iv) a request to create at least a second pick list;
confirming that the individual is authorized to perform the action; and
presenting the individual with at least a first data entry screen to perform the action.
